(19) United States
(12) Patent Application Publication
(10) Pub. No.: US 2026/0318146 A1
(43) Pub. Date: Oct. 15, 2026

(54) METHOD FOR AUTOMATICALLY OPENING A DOOR, AUTOMATIC DOOR, CORRESPONDING COMPUTER PROGRAM PRODUCT

(71) Applicant: dormakaba Deutschland GmbH, Ennepetal (DE)

(72) Inventors: Sven BUSCH, Ennepetal (DE); Dennis MEIERING, Ennepetal (DE); Patrick WINKELMANN, Ennepetal (DE)

(21) Appl. No.: 19/441,264

(22) Filed: Jan. 6, 2026

(30) Foreign Application Priority Data
Jan. 7, 2025 (EP) 25150554.1

(51) Int. Cl. E05F 15/73

(52) U.S. Cl. CPC E05F 15/73; E05Y 2900/132

(57) ABSTRACT

The method for automatically opening a door, an automatic door opening system and a corresponding computer program product are related. The method includes the step of observing a recording region in front of the door by way of a sensor device for determining movement data of at least one person. A control unit decides whether the door should be opened or remain open based on the determined movement data and classifying installation data of the door. The system is configured such that it takes into account different installation situations of the door to ensure an optimum decision-making process.

### CROSS-REFERENCE TO RELATED APPLICATIONS

This application claims the benefit of European patent application no. 25150554.1, filed on 7 Jan. 2025, the disclosure of which is incorporated herein by reference in its entirety.

### TECHNICAL FIELD

The present disclosure relates to a method for automatically opening a door, an automatic door opening system for automatically opening an automatic door, and a corresponding automatic door. The disclosure also relates to a corresponding computer program product for such automatic door opening systems or automatic doors, as well as a computer-implemented method for processing movement data for deciding on an opening process of an automatic door. Finally, the disclosure relates to a method for transferring operating information of a basic automatic door to a further automatic door and to a system for controlling entrances through automatic doors.

### BACKGROUND

In the field of automatic doors, for example rotating doors or sliding doors, it is known that various sensor devices are used to detect the movements of people in the corresponding recording region in front of the door and then to automatically open the door or, for example, hold it open or suppress a closing process that would otherwise take place.

The problem is also known in the prior art that not every movement of a person should lead to an opening movement of the door or to it being held open, but only those observed movements that have been caused by a person with an actual desire to enter. One known problem is that cross-traffic, i.e. people simply walking past the door in question, often leads to undesired opening movements of the door. Although with more intelligent door systems this incorrect door opening movement can sometimes be detected after initiation and the door that is not yet fully open can be closed again, overall such undesired opening movements or undesirably long holding open of doors lead on the one hand to increased energy consumption, as well as to greater wear of the door and ultimately often also to a loss of energy from heated or cooled rooms, in particular for example from the interior spaces of a building if it is an automatic external door.

A solution approach for operating automatic doors with fewer such incorrect openings is disclosed in EP 4 095 341 B1, from which the present disclosure proceeds and the content of which is to be included as a reference in the present application. According to EP 4 095 341 B1, one solution approach is to analyse the observed people or corresponding image data more precisely with regard to posture, viewing direction or foot position, for example, and to use this information to draw conclusions about a desire to enter, i.e. to decide whether or not the automatic door should be opened or remain open.

However, the known system can be further developed so that it is optimised for a plurality of automatic doors and a plurality of doors with different characteristics, such as the exact field of application of the door, can be equipped with specific optimised systems.

### SUMMARY

Against this background, the present disclosure provides a method for automatically opening a door, as well as to provide an automatic door opening system, an automatic door, a corresponding computer program product and a computer-implemented method for processing movement data for deciding an opening process of an automatic door, with which at least one of the problems described above is addressed. It is in particular an advantage to further reduce the incorrect opening processes by adjusting the door control system to the specific field of application of the door. Finally, it is an advantage of the disclosure to provide a method for transferring operating information of a basic automatic door to a further automatic door and a system for controlling entrances through automatic doors, with which at least one of the problems described above is addressed. It is in particular an advantage to equip automatic doors more quickly or with less effort with such an intelligent control system that incorrect opening processes are further reduced.

This advantage is achieved in relation to a method for automatically opening a door according to the features of the preamble of claim 1 by the features of the characterising part of claim 1, in relation to an automatic door opening system according to the features of the preamble of claim 9 by the features of the characterising part of claim 9, in relation to an automatic door by an automatic door having the features of claim 10, and in relation to a computer program product by the computer program product according to claim 11. Finally, the advantage is achieved in relation to a computer-implemented method for processing movement data for deciding an opening process of an automatic door according to the features of the preamble of claim 12 by the features of the characterising part of claim 12, in relation to a method for transferring operating information of a basic automatic door to a further automatic door by the method according to claim 14, and in relation to a system for controlling entrances through automatic doors by the system according to claim 15. Advantageous configurations are the subject matter of the dependent claims and the following description.

The central finding here is that it is no longer just the movement data of people that is analysed and taken into account, but that more precise and efficient control of the door is made possible by mapping the specific installation situation of the door in installation data and that this installation data is also taken into account by the control unit in its decision-making process about a door opening process. The inclusion of installation data for the door also makes it possible to take different installation situations into account and adjust the door control accordingly. A learning system can be provided, with which the installation situation can be recorded or updated during operation, as well as a system that benefits from other doors that have already been taught in previously. The installation data can be trained at the factory, for example by a control unit learning different movement patterns suitable for the corresponding installation situation and the decisions to be derived therefrom for an opening process at the factory, or experience from a specifically installed door with an identical or at least similar installation situation can be used to intelligently equip the new door with the empirical values. The installation data provides a parameterisation of the automatic door that is suitable for the specific installation situation such that it can adjust its decision-making process for door opening processes specifically to the movement patterns of the people in that installation situation.

More specifically, according to a first independent aspect of the disclosure, as recited in claim 1, a method for automatically opening a door is proposed, which method comprises at least the following steps a) to c):
a) Observing a recording region in front of the door with a sensor device for determining movement data of at least one person.
b) Deciding by means of a control unit whether the door should be opened or remain open based on the previously determined movement data provided to the control unit.
c) Carrying out an opening movement of the door if it is decided in step b) that the door should be opened or maintaining an open position if it is decided in step b) that the door should remain open.

The proposed method is characterised in that the control unit makes the decision in step b) based both on the determined movement data and on installation data classifying an installation situation of the door.

The installation data can comprise specific parameters and/or configurations that represent or describe the spatial arrangement and/or environmental conditions of the door. This can include information about the proximity to walls, corners or passages, or the type of adjoining region (e.g. corridor, open room, passing region with obstacles to free movement of people) and, in particular, the typical movement patterns of people in the environment of the door.

Installation data can be static information that is defined once when the door is installed or transmitted once to the door or selected in the door from a package of a plurality of data sets, or dynamic data that can be continuously updated during operation of the door in order to react to changes in the environment or in use behaviour.

The installation data can be a data set or a plurality of (selectable) data sets in which a certain decision logic is stored, by means of which decision logic the control unit can decide to open or hold open the door based on the movement patterns transmitted to it and currently recorded by the door. It can also be an Al algorithm or an intelligent system such that the control unit has been made intelligent for the installation situation based on the installation data in order to best detect the movement patterns that are suitable to the installation situation and thus be able to control the opening processes in a targeted manner.

For example, the control unit can use the installation data to adjust the sensor sensitivity and/or the decision logic. For example, the sensor sensitivity can be reduced in a busy corridor to minimise incorrect openings caused by cross-traffic.

The installation data can therefore be used to identify specific movement patterns that indicate an actual desire to enter. This can also be done using machine learning, in which the control unit learns from historical movement data which patterns should typically lead to a door opening.

In this context, reference should also be made to the aforementioned disclosure EP 4 095 341 B1, the content of which is to be included by reference in the present application. The disclosure also describes improved door opening methods using specific recorded probability values or adjustments of threshold values by analysing the provided image data, with the principal possibility of using Al-algorithms. In particular, there is disclosed a door operating system comprising a control unit and at least one sensor device, with the control unit being configured to receive and process observation image data to determine the probability that a person wishes to pass through the door. This technique can also be used in the present disclosure to further improve the accuracy and efficiency of door control. Reference is also made to the applicant's Motion IQ technology, which can also be used in the present subject matters of the application.

The control unit can preferably be configured to receive and process observation image data. This can include detecting individuals among other objects in the recording region, including distinguishing between individuals and non-individuals based on the shape of a detected object. Detecting and analysing individuals can be supported by artificial intelligence. This includes extracting posture information and viewing direction information to determine the intention of the person to pass through the door. Based on the extracted information (posture and viewing direction), a probability value can be calculated which represents the probability that the respective person wants to pass through the door. The control unit can decide whether the door should be opened by comparing the probability value with a predefined threshold value. If the probability value is higher than the threshold value, the door is opened. Detecting and analysing individuals and extracting features can be improved by machine learning. This may comprise the use of training data to increase the accuracy of detection and analysis.

The use of AI algorithms to analyse movement data and adjust the door control based on the probability values determined can in particular help to minimise incorrect openings and optimise energy consumption.

In a dynamic environment, the installation data can be regularly verified and adjusted to ensure that the door control is optimised for current conditions. This can be achieved by integrating real-time data analyses and adaptive algorithms.

By taking the installation data into account, the door control can be designed more precisely and efficiently, which can lead to a reduction in incorrect openings and lower energy consumption.

In principle, one or a plurality of sensors can be used as the sensor device, including radar sensors, lidar sensors, optical sensors or cameras, as well as ultrasonic sensors or infrared sensors, as well as combinations of the aforementioned sensors.

According to one exemplary embodiment of the method for automatically opening a door, it is provided that the installation data is static in such manner that it is predetermined for operating the door.

Alternatively, it is also provided that the installation data is dynamic in such manner that it can be adjusted during operation of the door. The installation data can in particular be verified by means of movement patterns based on determined movement data and can be updated or is updated.

The control unit can preferably be configured such that it takes into account at least two different installation situations of the door, and furthermore that it takes into account at least three different installation situations of the door.

According to a further exemplary embodiment of the method for automatically opening a door, it is provided that the installation data can be selected with regard to at least two installation situations, preferably at least three installation situations, of the door. The installation data can in particular initially be set to operate the door.

The installation situations can preferably include the following:
a specific installation situation in relation to an adjoining wall course and/or in relation to an adjacent wall course; and/or
a specific installation situation in relation to a passable region in an immediate environment of the door; and/or
a specific installation situation in relation to the functionality of at least one room surrounding the door or the building containing the door.

Consequently, it may be provided that the installation situations comprise the position of the door in relation to wall courses in the environment of the door and/or that the installation situations comprise the position of the door in relation to passable regions in the environment of the door.

According to a further exemplary embodiment of the method for automatically opening a door, it is provided that a specific installation situation comprises a corner installation situation. The door is preferably configured to operate close to a corner or adjacent passage, with the door being arranged within 3 metres, preferably 2 metres, adjacent to the corner or to the passage of a wall in which the door is installed. There is therefore a corner of the same wall or another possible passage on the same wall within a short distance of the door or the door opening through which people can pass. With such doors, specific movement patterns of people can occur in particular, with the movements of people initially being able to suggest that the person is walking towards the door, but they do not want to go through the door at all, but rather walk past it around the nearby corner or the adjacent passage. Doors with such an installation situation can preferably recognise or be taught certain movement patterns that characterise such “people walking towards the door but past the door” via parameterisation by means of the installation data, such that fewer incorrect openings or less time spent holding a door open incorrectly result.

According to a further exemplary embodiment of the method for automatically opening a door, it is provided that a specific installation situation comprises a central installation situation. The door is preferably configured to operate centrally in a wall, with the door being installed in a wall without an adjacent corner and without an adjacent passage within at least 2 metres, preferably at least 3 metres.

According to a further exemplary embodiment of the method for automatically opening a door, it is provided that a specific installation situation comprises a corridor installation situation. The door is preferably configured to operate in a corridor, with the door being installed in a side wall of the corridor with an opposing wall within 4 metres, preferably 3 metres. There is therefore another wall within a short distance opposite the door or opposite the door opening through which people can pass. In the case of such doors in a so-called corridor situation, there may in particular be increased cross-traffic relatively close to the door without the people in question wanting to pass through the door. Corresponding specific movement patterns of people, in which the movements of people may initially suggest that the person is walking towards the door, but does not want to pass through the door at all, but rather walk past it at right angles, can be known to the door according to the proposal via parameterisation by means of the installation data or can be learned by the door via parameterisation by means of the installation data such that fewer incorrect opening processes or less time spent holding a door open incorrectly result.

According to a further exemplary embodiment of the method for automatically opening a door, it is provided that a specific installation situation comprises a passing installation situation. The door is preferably configured for operation in a limited passing region, in particular adjoining a road, for example on a pavement, with the door being installed in a wall with an opposing impassable region within 4 metres, preferably 3 metres. There is therefore a kind of obstacle within a short distance opposite the door or opposite the door opening that people can pass through, which prevents people from walking along it. In the case of such doors in a so-called passing situation, there may in particular be increased cross-traffic relatively close to the door without the people in question wanting to pass through the door. Corresponding specific movement patterns of people, in which the movements of people may initially suggest that the person is walking towards the door, but does not want to pass through the door at all, but rather walk past it at right angles, can be known to the door according to the proposal via parameterisation by means of the installation data or can be learned by the door via parameterisation by means of the installation data such that fewer incorrect opening processes or less time spent holding a door open incorrectly result.

According to a further exemplary embodiment of the method for automatically opening a door, it is provided that a specific installation situation comprises an application field installation situation. The door is preferably configured to operate for certain specific groups of people passing through. For example, other specific movement patterns of people may be typical for automatic doors in a shopping centre, airport or hotel, which specific movement patterns can in turn be taught in via the installation data and made available to the door for decision-making. This can result in fewer incorrect opening processes or fewer times that a door is held open incorrectly. Another example of a corresponding application field is doors in buildings that are facilities with children or infants, where certain movement patterns that are specific to infant movements are taken into account in the decision-making process in such manner that, for example, doors are not opened.

According to a further exemplary embodiment of the method for automatically opening a door, it is provided that the installation data has been or is extracted as extracted installation data from an automatic basic door. Old doors or doors that are still in operation at the same time can in particular serve as a kind of template and the experience gained there in relation to the specific installation situation can be transferred to the new or current automatic door in the form of a parameterisation in the form of the installation data. This can be done by providing specific past training data, for example from doors trained at the factory or other doors in use, or virtually live by transferring installation data online, for example via a cloud application, from a basic door to the current one. The basic door refers to a door with the same or at least a similar installation situation. Advantageously, only the basic door can then be intelligently equipped in such manner that it continues to learn on the basis of the movement patterns recorded there and thus updates or improves the corresponding installation data, while the other door or other doors, which in turn learns/learn from the basic door via the installation data provided, can then be configured more simply and do not have to be self-learning, for example.

According to a further exemplary embodiment of the method for automatically opening a door, it is provided that the installation data is provided as a data set for an algorithm or as an algorithm itself. It can preferably be an Al algorithm. The algorithm, in particular the Al algorithm, is preferably configured to analyse the determined movement data and, based on this analysis, to determine a probability value that represents the probability that the door should actually be opened or remain open. The control unit preferably has a decision logic that initiates the opening movement of the door if the probability value exceeds a predefined threshold value. A result as to whether the opening movement was correctly initiated or not initiated is preferably used to update the data set or algorithm, in particular the AI algorithm.

When using an AI algorithm in particular, historical movement data, either from other doors with similar or identical installation situations or even the same door, can be used as empirical values or training data for the algorithm in order to make a more accurate decision about an opening process of the automatic door.

According to a further exemplary embodiment of the method for automatically opening a door, it is provided that the door is a building door, in particular an interior door or exterior door, and/or a sliding door or a rotating door.

According to a further independent aspect of the present disclosure, there is proposed an automatic door opening system for automatically opening an automatic door as recited in claim 9, the automatic door opening system comprising at least the following:
a) a sensor device for determining movement data of at least one person in a recording region in front of the automatic door;
b) a control unit that is configured to decide whether the automatic door should be opened or remain open based on the previously determined movement data;
c) a drive unit that is configured to carry out an opening movement of the automatic door if it is decided by the control unit that the automatic door should be opened.

The proposed automatic door opening system is characterised in that the control unit is configured to make the decision based both on the determined movement data and on installation data classifying an installation situation of the automatic door.

The proposed automatic door opening system, as described above or in claim 9 or below, is in particular configured to carry out a proposed method for automatically opening a door, as described above or in one of claims 1 to 8 or below.

The proposed method for automatically opening a door, as described above or in one of claims 1 to 8 or below, is in particular configured to operate a proposed automatic door opening system, as described above or in claim 9 below, or to operate a proposed automatic door, as described in claim 10 or below.

Features described above or below only in relation to one type of subject matter of the disclosure, for example only in relation to a method for automatically opening a door, can be transferred in a technically meaningful way to the other subject matters of the claims in an adapted manner, for example in the form of the automatic door opening system, and form further proposed configurations. The proposed automatic door opening system or its components can be configured to carry out the method steps described. Features can also be transferred in a technically meaningful way between the subordinate independent subject matters of the method or devices and systems and form independent exemplary embodiments in each case.

According to a further independent aspect of the present disclosure, there is proposed an automatic door as recited in claim 10, which automatic door is characterised by a proposed automatic door opening system as described above or in claim 9 or below. The proposed automatic door can in particular be a building door, in particular an interior or exterior door. Furthermore, the proposed automatic door can be a sliding door or a rotating door.

The proposed automatic door, as described above or in claim 10 or below, is in particular configured to carry out a proposed method for automatically opening a door, as described above or in one of claims 1 to 8 or below.

According to a further independent aspect of the present disclosure, there is proposed a computer program product as recited in claim 11, which computer program product comprises instructions which cause the proposed automatic door opening system as described above or in claim 9 or below, or the proposed automatic door as described above or in claim 10 or below, to carry out the method steps of the proposed method for automatically opening a door as described above or in one of claims 1 to 8 or below.

According to a further independent aspect of the present disclosure, as recited in claim 12, there is proposed a computer-implemented method for processing movement data for deciding an opening process of an automatic door, in particular a proposed automatic door, as described above or in claim 10 or below, which computer-implemented method comprises at least the following steps:
Providing a trained algorithm, which trained algorithm is configured to make a decision of an opening process of an automatic door based on movement data, with the trained algorithm being trained on the basis of historical movement data with known decisions of corresponding opening processes.
Determining current movement data of at least one person with a sensor device by observing a recording region in front of the automatic door.
Deciding whether the automatic door should be opened or remain open by applying the trained algorithm to the previously determined current movement data.

The proposed computer-implemented method is characterised in that the decision is made based both on the determined current movement data and on installation data classifying an installation situation of the automatic door.

The proposed computer-implemented method for processing movement data for deciding an opening process of an automatic door, as described above or in claim 12 or below, is in particular configured to operate a proposed automatic door opening system as described above or in claim 9 or below, or to operate a proposed automatic door as described above or in claim 10 or below.

The proposed automatic door opening system (as described above or in claim 9 or below) and the proposed automatic door (as described above or in claim 10 or below) are in particular configured to carry out the proposed computer-implemented method for processing movement data for deciding an opening process of an automatic door, as described above or in claim 12 or below.

According to a further exemplary embodiment of the computer-implemented method, it is provided that the trained algorithm is trained specifically for only one specific installation situation of the automatic door. Alternatively, it can be provided that the trained algorithm is trained for a plurality of different specific installation situations of the automatic door.

The concrete specific installation situation of the automatic door can preferably be selected when the computer-implemented method is applied or recognised automatically when the computer-implemented method is carried out.

According to a further independent aspect of the present disclosure, a computer program product is proposed, which computer program product comprises instructions which cause the proposed automatic door opening system as described above or in claim 9 or below, or the proposed automatic door as described above or in claim 10 or below, to carry out the method steps of the proposed computer-implemented method for processing movement data for deciding an opening process of an automatic door as described above or in one of claims 12 or 13 or below.

According to a further independent aspect of the present disclosure, as recited in claim 14, there is proposed a method for transferring operating information of a basic automatic door to a further automatic door, in particular to a proposed automatic door as described above or in claim 10 or below, which method is characterised by at least the following steps:
a) Extracting installation data of the automatic basic door by extracting specific operating data for an installation situation of the automatic basic door.
b) Transferring the extracted installation data of the basic automatic door to a control unit of the further automatic door with an at least similar installation situation in order to optimise the decision-making process of the further automatic door

The control unit of the further automatic door is configured to make the decision based both on movement data determined by the further automatic door and on the extracted installation data of the automatic basic door.

According to a further independent aspect of the present disclosure, there is proposed a system for controlling entrances through automatic doors as recited in claim 15, with the at least two automatic doors comprising an automatic basic door and at least one further automatic door, in particular a proposed automatic door as described above or in claim 10 or below, and wherein as follows:
the automatic basic door is equipped with a sensor device for determining movement data of at least one person and with a unit for extracting installation data by extracting specific operating data for an installation situation of the automatic basic door; and
the further automatic door is equipped with a sensor device for determining movement data of at least one person and a control unit.

The system has a means for transferring the extracted installation data of the automatic basic door to the control unit of the further automatic door, and the control unit of the further automatic door is configured to make a decision of an opening process based both on the movement data determined by the further automatic door and on the extracted installation data of the automatic basic door.

The proposed system for controlling entrances through automatic doors, as described above or in claim 15 or below, is in particular configured to carry out a proposed method for transferring operating information of an automatic basic door to a further automatic door, as described above or in claim 14 or below.

The proposed method for transferring operating information of a basic automatic door to a further automatic door, as described above or in claim 14 or below, is in particular configured to operate a proposed system for controlling entrances through automatic doors, as described above or in claim 15 or below.

According to a further independent aspect of the present disclosure, a computer program product is proposed, which computer program product comprises instructions which cause the proposed system for controlling entrances through automatic doors, as described above or in claim 15 or below, to carry out the method steps of the proposed method for transferring operating information of a basic automatic door to a further automatic door, as described above or in claim 14 or below.

Further advantageous and preferred configurations are shown in the following description with reference to the figures. In the drawing, which only reflects exemplary embodiments, the following is shown:

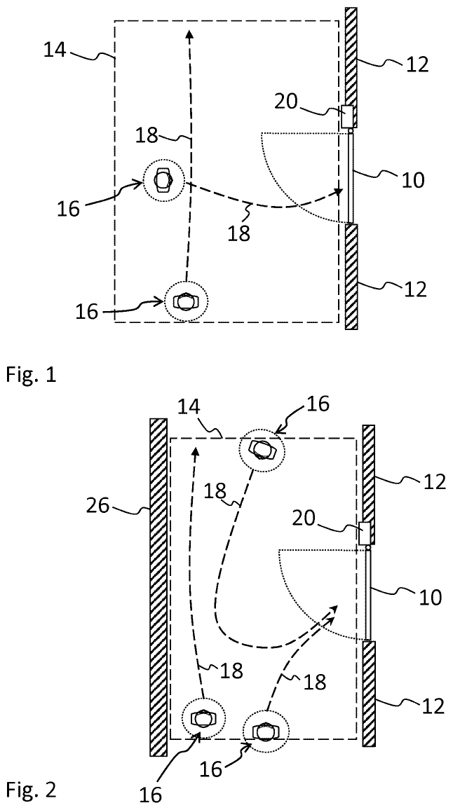

FIG. 1 a schematic top view of a proposed automatic door, in this case a rotating door, according to a central installation situation with illustrated people and movements of people in the recording region in front of the door;

FIG. 2 a schematic top view of a proposed automatic door, in this case a rotating door, according to a corridor installation situation with illustrated people and movements of people in the recording region in front of the door;

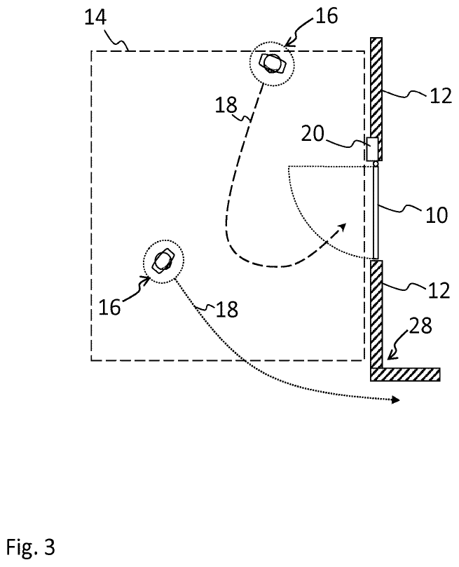

FIG. 3 a schematic top view of a proposed automatic door, in this case a rotating door, according to a corner installation situation with illustrated people and movements of people in the recording region in front of the door;

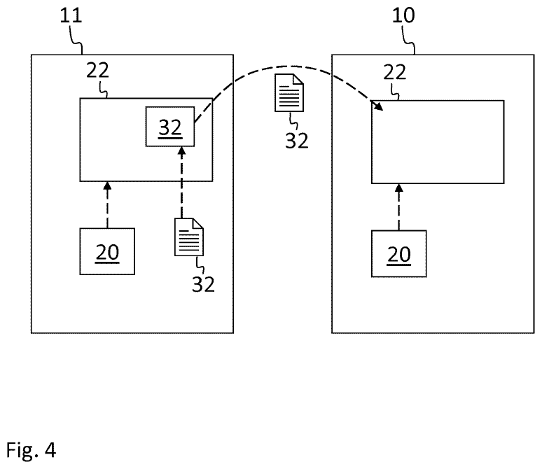

FIG. 4 a schematic view of a proposed system for controlling entrances through automatic doors;

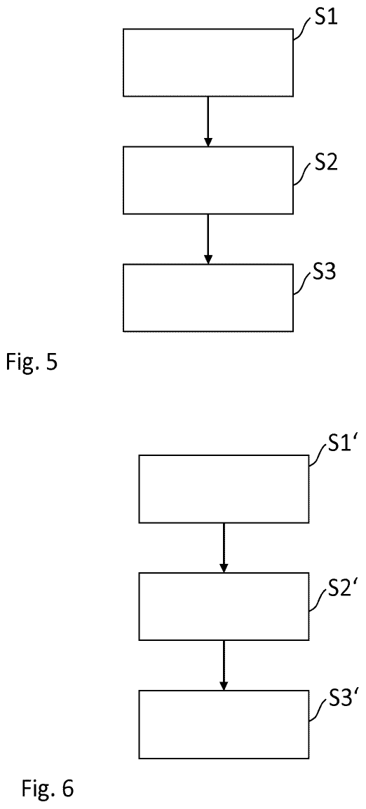

FIG. 5 a flow diagram of a proposed method for automatically opening a door;

FIG. 6 a flow diagram of a proposed computer-implemented method for processing movement data for deciding an opening process of an automatic door; and

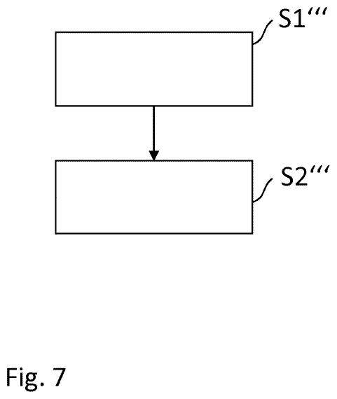

FIG. 7 a flow diagram of a proposed method for transferring operating information of a basic automatic door to a further automatic door.

FIG. 1 shows a schematic top view of a proposed automatic door 10, in this case a rotating door (rotating opening movement indicated by a dotted pitch circle), according to a central installation situation. The door 10 is installed centrally in a wall 12 without an adjacent corner and without an adjacent passage in the vicinity, and furthermore without an opposing wall. In principle, the door 10 is therefore also freely accessible and the region in front of it is freely passable. In the recording region 14 in front of the automatic door 10, persons 16 and their movement paths 18 are illustrated with dashed arrows.

The door 10 or its corresponding automatic door opening system has a sensor device 20, which records movement data of the persons 16 in the recording region 14 and transmits it to the control unit 22 of the door 10. The control unit 22 analyses the movement data, also taking into account installation data classifying the specific installation situation of the automatic door 10 as a central door, and decides whether the door 10 should be opened. The installation data here includes the central position of the door in the wall 12, as well as a decision logic or an intelligent algorithm for deciding how and by what means certain movement patterns of persons 16 in the specific installation situation are to be decided upon regarding the door opening. If the decision-making process of the control unit 22 proceeds in such manner that the door 10 should be opened, a drive unit, not represented, opens the door 10 automatically.

FIG. 2 shows a schematic top view of a further proposed automatic door 10, in this case again a rotating door, with the door 10 differing from the door 10 according to FIG. 1 only in the installation situation, in that here in FIG. 2 there is a corridor installation situation. The door 10 is therefore installed in a side wall of a corridor, with the opposing wall 26 lying within a distance of 4 metres. Once again, persons 16 and their movement paths 18 are represented in the recording region 14 in front of the door 10. Due to the now different installation data, the decision logic or the Al algorithm used (or its configuration or data set) is different, such that specific movement patterns are responded to differently with regard to the decision-making process of a door opening than in the situation according to FIG. 1.

FIG. 3 shows a schematic top view of a further proposed automatic door 10, in this case again a rotating door, with the door 10 differing from the door 10 according to FIG. 1 or FIG. 2 only in the installation situation, in that here in FIG. 3 there is a corner installation situation. The door 10 is therefore arranged near a corner 28. Alternatively, it could also be a door arranged near an adjacent passage. The corner 28 is arranged within 2 metres adjacent to the door 10 in the same wall 12. Persons 16 and their movement paths 18 in the recording region 14 in front of the door 10 are illustrated again. Due to the now different installation data, the decision logic or the Al algorithm used (or its configuration or data set) is different, such that specific movement patterns are responded to differently with regard to the decision-making process of a door opening than in the situation according to FIG. 1 or FIG. 2. As an example, reference is made to the person 16 with the movement path labelled with dots. This person 16 would possibly still trigger an opening process of the respective door based on the recorded movement data and the movement that initially still appears to be walking towards the door 10 in the embodiments according to FIG. 1 or FIG. 2, whereas in the present case according to FIG. 3, however, due to the adjacent corner 28 and the associated possibility that this person 16 could also want to walk past the door 10 and corner 28, it initially waits longer with a possible opening process and finally actually decides against such an opening process, since the movement path of the person 16 is actually directed past the corner 28. The installation data provided and the associated intelligence of the door 10 according to FIG. 3 thus prevent unnecessary opening processes.

FIG. 4 shows a schematic view of a proposed system for controlling entrances through automatic doors. The system comprises a first automatic door 11 in the form of a basic door 11, with a sensor device 20 and a control unit 22. The control unit 22 is equipped with a communication interface 32 that can exchange data with external systems. The installation data 34, which in the case of the basic door 11 was obtained due to its property as an intelligent door with a feedback function, via which feedback function the basic door 11 characterises the decisions it has made about door openings as correct or incorrect based on the movements it has recorded and the persons actually passing through, are stored in the control unit 22 and can be used to adjust the door control of the basic door 11. In this way, the experience of the basic door 11, which is specific to its installation situation, can be obtained and stored in order to improve future decision-making processes.

The proposed system represented in FIG. 4 also has a further automatic door 10, which may also be a door 10 as already represented and described above. Via the control unit 22 of the basic door 11 or the communication interface 32, the previously described obtained installation data 34 can be extracted and also transferred to a control unit 22 of said further automatic door 10 with an at least similar installation situation in order to optimise the decision-making process about door openings of this further automatic door 10. The further automatic door 10 can therefore benefit from the experience of the basic door 11. Advantageously, the further automatic door 11 then no longer needs to be configured as intelligently and, for example, does not need to have an Al algorithm, such as for example the basic door 11, which basic door 11 takes over the work in the form of specific information acquisition for the specific installation situation.

FIG. 5 shows a flow diagram of a proposed method for automatically opening a door. The method comprises the following steps: In step S1, a recording region in front of the door is observed using a sensor device for determining movement data of at least one person. In step S2, a control unit is used to decide whether the door should be opened or remain open based on the previously determined movement data provided to the control unit and also based on the installation data classifying the installation situation of the door. In step S3, an opening movement of the door may then be carried out or the open door is held open if it is decided in step b) that the door should be opened or remain open.

FIG. 6 shows a flow diagram of a proposed computer-implemented method for processing movement data for deciding on an opening process of an automatic door. The method comprises the following steps: In step S1′, a trained algorithm is provided, which is configured to make a decision of an opening process of an automatic door based on movement data, with the trained algorithm being trained on the basis of historical movement data with known decisions of corresponding opening processes. The training can, for example, take place for the door on the factory floor under test conditions or in field tests, or another door can be trained in use. In step S2′, current movement data of at least one person is determined using a sensor device by observing a recording region in front of the automatic door. In step S3′, a decision is then made as to whether the automatic door should be opened or remain open by applying the trained algorithm to the previously determined current movement data, with this decision being made based both on the determined current movement data and on installation data classifying an installation situation of the automatic door.

FIG. 7 shows a flow diagram of a proposed method for transferring operating information of a basic automatic door to further automatic door. The method comprises the following steps: In step S1″, installation data of the automatic basic door is extracted by extracting specific operating data for an installation situation of the automatic basic door. Then, in step S2″, the extracted installation data of the automatic basic door is transferred to a control unit of the further automatic door with an at least similar installation situation in order to optimise a decision-making process of the further automatic door. The control unit of the further automatic door is configured to make the decision based both on movement data determined by the further automatic door and on the extracted installation data of the automatic basic door. The parameterisation of the further automatic door is therefore carried out by adopting installation data of the basic door, which is used by the further automatic door to optimise the opening processes based on the empirical values and specific detected movement patterns as well as the resulting decision-making processes on door openings of the basic door. This is advantageous so that a plurality of doors with the same or similar installation situations do not have to be taught in or parameterised again each time. A large number of different doors can be given a suitable configuration depending on their specific installation situation and react in the best possible way to specific movement patterns of people.

1. A method for automatically opening a door, the method including at least the following steps:
a) Observing a recording region in front of the door with a sensor device or determining movement data of at least one person;
b) Deciding by way of a control unit whether the door should be opened or remain open based on the previously determined movement data provided to the control unit; and
c) Carrying out an opening movement of the door if it is decided in step b) that the door should be opened;
wherein the control unit makes the decision in step b) based both on the determined movement data and on installation data that classify the installation situation of the door.

2. The method according to claim 1, wherein the installation data is static such that the installation data is predetermined for operating the door.

3. The method according to claim 1, wherein the installation data is dynamic such that the installation data is adjustable during the operation of the door;
wherein, preferably, the installation data is verified and configured to be updated or is updated by way of movement patterns based on determined movement data.

4. The method according to claim 1, wherein the installation data is selectable with regard to at least two installation situations, preferably at least three installation situations, of the door, preferably furthermore initially adjustable for operating the door;
wherein, preferably, the installation situations comprise the following:
a specific installation situation in relation to an adjoining wall course and/or in relation to an adjacent wall course;
and/or
a specific installation situation in relation to a passable region in an immediate environment of the door;
and/or
a specific installation situation in relation to the functionality of at least one room surrounding the door or the building containing the door.

5. The method according to claim 1, wherein a/the specific installation situation comprises the following:
a corner installation situation;
wherein, preferably, the door is configured to operate close to a corner or adjacent passage, wherein the door is arranged within 3 metres, preferably 2 metres, adjacent to the corner or passage of a wall in which the door is installed;
and/or
a central installation situation;
wherein, preferably, the door is configured to operate centrally in a wall wherein the door is installed in a wall without an adjacent corner and without an adjacent passage within at least 2 metres, preferably at least 3 metres;
and/or
a corridor installation situation;
wherein, preferably, the door is configured to operate in a corridor, wherein the door is installed in a side wall of the corridor with an opposing wall within 4 metres, preferably 3 metres;
and/or
a passing installation situation;
wherein, preferably, the door is configured to operate in a limited passing region, in particular adjoining a road, for example on a pavement, wherein the door is installed in a wall with an opposing impassable region within 4 metres, preferably 3 metres;
and/or
an application field installation situation;
wherein, preferably, the door is configured to operate for certain specific groups of people passing through.

6. The method according to claim 1, wherein the installation data has been or is extracted as extracted installation data from an automatic basic-door.

7. The method according to claim 1, wherein the installation data is itself present as a data set for an algorithm, in particular an AI-algorithm, or as an algorithm, in particular AI-algorithm;
wherein, preferably, the algorithm, in particular the AI-algorithm, is configured to analyse the determined movement data and, based on this analysis, to determine a probability value representing the probability that the door actually whether the door should be opened or remain open;
wherein, preferably, the control unit has a decision logic which triggers the opening movement of the door the probability value exceeds a predefined threshold value;
wherein, preferably, a result as to whether the opening movement has been correctly initiated or not initiated is used to update the data set or algorithm, in particular AI-algorithm.

8. The method according to claim 1, wherein the door is a building door, in particular an interior door or exterior door, and/or
is a sliding door or a rotating door.

9. An automatic door opening system for automatically opening an automatic door, comprising at least:
a) a sensor device for determining movement data of at least one person in a recording region in front of the automatic door;
b) a control unit that is configured to decide whether the automatic door should be opened or remain open based on the previously determined movement data;
c) a drive unit that is configured to carry out an opening movement of the automatic door if it is decided by the control unit that the automatic door should be opened;
wherein the control unit is configured to make the decision based both on the determined movement data and on installation data that classify the installation situation of the door.

10. An automatic door characterised by an automatic door opening system according to claim 9;
wherein, preferably, the door is a building door, in particular an interior door or exterior door, and/or
is a sliding door or a rotating door.

11. A computer program product comprising instructions which cause an automatic door opening system for automatically opening an automatic door, comprising at least:
a) a sensor device for determining movement data of at least one person in a recording region in front of the automatic door:
b) a control unit that is configured to decide whether the automatic door should be opened or remain open based on the previously determined movement data:
c) a drive unit that is configured to carry out an opening movement of the automatic door if it is decided by the control unit that the automatic door should be opened;
wherein the control unit is configured to make the decision based both on the determined movement data and on installation data that classify the installation situation of the door to carry out the method steps according to claim 1.

12. A computer-implemented method for processing movement data for deciding an opening process of an automatic door, in particular according to claim 10, comprising at least the following steps:
Providing a trained algorithm, which trained algorithm is configured to make a decision of an opening process of an automatic door 10 based on movement data, wherein the trained algorithm is trained on the basis of historical movement data with known decisions of corresponding opening processes;
Determining current movement data of at least one person with a sensor device observing a recording region in front of the automatic door;
Deciding whether the automatic door should be opened or remain open by applying the trained algorithm to the previously determined current movement data;
wherein the decision is made based both on the determined current movement data and on the installation data that classify the installation situation of the door.

13. The computer-implemented method according to claim 12, wherein the trained algorithm is trained specifically for only one specific installation situation of the automatic door;
or wherein the trained algorithm is trained for a plurality of different specific installation situations of the automatic door;
wherein, preferably, the concrete specific installation situation of the automatic door is selected when the computer-implemented method is applied or is recognised automatically when the computer-implemented method is carried out.

14. The method for transferring operating information of an automatic basic door to a further automatic door, in particular according to claim 10, characterised by at least the following steps:
Extracting installation data (34) of the automatic basic door by extracting specific operating data for an installation situation of the automatic basic door;
b) Transferring the extracted installation data of the automatic basic door to a control unit of the further automatic door with an at least similar installation situation in order to optimise a decision-making process of the further automatic door;
wherein the control unit of the further automatic door is configured to make the decision based both on movement data determined by the further automatic door and on the extracted installation data of the automatic basic door.

15. A system for controlling entrances through automatic doors, comprising at least two automatic doors, wherein the at least two automatic doors comprise an automatic basic door and at least one further automatic door, in particular according to claim 10, wherein
the automatic basic door is equipped with a sensor device for determining movement data of at least one person and with a unit for extracting installation data by extracting specific operating data for an installation situation of the automatic basic door; and
the further automatic door is equipped with a sensor device for determining movement data of at least one person and a control unit;
wherein the system comprises a means for transferring the extracted installation data of the automatic basic door to the control unit of the further automatic door, and wherein the control unit of the further automatic door is configured to make a decision of an opening process based both on the movement data determined by the further automatic door and on the extracted installation data of the automatic basic door.
